(19) United States
(12) Patent Application Publication
(10) Pub. No.: US 2020/0048086 A1
(43) Pub. Date: Feb. 13, 2020

(54) THERMAL HYDROGEN

(71) Applicant: Jared Moore, Silver Spring, MD (US)

(72) Inventor: Jared Moore, Silver Spring, MD (US)

(21) Appl. No.: 16/655,791

(22) Filed: Oct. 17, 2019

Related U.S. Application Data
(63) Continuation of application No. PCT/US2018/028144, filed on Apr. 18, 2018.
(60) Provisional application No. 62/486,548, filed on Apr. 18, 2017.

(51) Int. Cl. C01B 3/36; C01B 3/12; C25B 1/04

(52) U.S. Cl. CPC C01B 3/36; B60L 50/70; C25B 1/04; C01B 3/12

(57) ABSTRACT

Methods and systems for emissions free dispatchable power supply, emissions free chemical energy storage, and emissions free chemical energy distribution are disclosed. Methods include providing water and/or carbon dioxide to an electrolyser; providing electricity from a regional electrical power grid to the electrolyser for electrolysis of the water and/or carbon dioxide to produce oxygen; and providing the oxygen from the electrolyser to a hydrocarbon oxidation device for the oxidation of a hydrocarbon.

### CROSS-REFERENCE TO RELATED APPLICATION

This application is a continuation of PCT/US2018/028144, filed Apr. 18, 2018 which claims the benefit of U.S. Provisional Application No. 62/486,548, filed on Apr. 18, 2017, which is hereby incorporated by reference.

### FIELD OF INVENTION

The present invention relates to the field of dispatchable power production, chemical energy storage and distribution, and CO₂ Sequestration.

### BACKGROUND

Thomas Edison and Henry Ford both made a similar insight ahead of their peers—the identification of a pragmatic and efficient energy carrier. This enabled the high-level engineering of a distribution system, which then enabled the specifications for the inventions they are credited for but did not actually invent—the light bulb and the automobile.

In Thomas Edison's patent application, he claimed to, “ . . . have invented an Improvement in Electric Lamps . . . ”. Edison summarized his insight primarily by its distribution properties rather than the bulb's filament, shape, or pressure: “The object of this invention is to produce electric lamps giving light by incandescence, which lamps shall have high resistance, so as to allow of the practical subdivision of the electric light.”

As a pioneer of tele-communications, Edison recognized the importance of distribution costs, and described copper as, “ . . . really, the crux of the problem”. His system featured “practical subdivision of the electric light” allowing each lamp to be dispatched as needed. Edison could dispatch light as needed, requiring fuel only as needed, while requiring hundreds of times less copper than the arc-lamp system.

The importance of distribution is not unique to electricity—it is the essence of meeting energy services conveniently with an economically viable supplier. Fuel from some time and place must provide an energy service to a different time and place. No system can be perfect due to the lack of congruence on both spatial and temporal dimensions. Inevitably, there will be energy inefficiency and/or underutilization of capital somewhere in the system.

In 1896, almost two decades after Edison submitted his electric lamp patent, he met a young Henry Ford. Edison summarized the advantages of Ford's system, again, through distribution:
“Young man, that's the thing; you have it . . . . Electric cars must keep near to power stations. The storage battery is too heavy . . . . Your car is self-contained—carries its own power plant—no fire, no boiler, no smoke and no steam. You have the thing.”
   Ford reflected on the significance of Edison's encouragement:
“ . . . The man who knew most about electricity in the world had said that for the purpose my gas motor was better than any electric motor could be—it could go long distances, he said, and there would be stations to supply the cars with hydro-carbon. That was the first time I ever heard this term for liquid fuel.”

For the light bulb and the automobile, the design of a small and efficient distribution system was paramount. Edison, sought to minimize the size of the copper wiring needed, thus the importance of “high-resistance” bulbs. Ford, by using a dense, pumpable “liquid fuel”, was able to minimize the size of pipes/storage tanks required for distribution, allowing him to concentrate on building a less steel-intensive automobile, which lead to a well utilized (i.e. less steel-intensive) automobile factory. In a manner of speaking, they both sought out incompressible, yet highly portable energy carriers to maximize value of copper and steel.

Of course, these systems are not perfect, not from an engineering perspective, let alone a social perspective. In order to take advantage of the spatial (long distance) abilities of electricity and liquid fuels, a device which provides reliable, dispatchable power is required to buffer temporal (timing) differences. Both distribution systems require an infrequently utilized dispatchable heat engine to maintain a reliable source of on-demand power.

Unfortunately, fossil fuel heat engines are ideally situated to provide this dispatchable power because of their low up-front capital costs. The fossil energy has been stored for millennia and can be purchased as needed. Therefore, the cost of capacity is as low as possible, starting at around ˜$1000/kW. Nuclear power plants, which also have a heat engine, have capital costs five times as high.

The low cost of capacity is notable given the low utilization of these assets. Power plant utilization in most developed countries average around ˜50%. In transportation, when a vehicle is cruising down the highway, the engine typically uses somewhere around 10% of its overall power rating.

The cost of this underutilization is particularly damning for emissions free power plants. If a nuclear power plant is utilized half the time, its average costs roughly double because of its high capital costs and very low marginal costs. For a fossil fuel power plant, however, halving the utilization of the plant might increase average costs by only 20% since fuel is saved when the power plant is idled.

Heat engines also suffer from relatively poor efficiency. Due to “Carnot losses” and other losses in the heat engine, power plants typically have an efficiency in the 30% to 55% range whereas internal combustion engines have an efficiency in the range of 25%-35%.

These systems are not perfect, but they are extremely competitive because their distribution systems are pragmatic, efficient, and compact. The cost of underutilized capacity is manageable because of the low cost of fossil fuel heat engines. The cost of inefficiency, similarly, is manageable due to the abundance of fossil fuels.

In Table 1 below, I show the shared principle characteristics of Edison's and Ford's system.

TABLE 1
Principle Characteristics of Edison and Ford's Energy Systems

| | Edison | Ford |
|---|---|---|
| Energy Service | Light (power) | Mobile power |
| Energy Carrier | “High resistance” | “Liquid fuel” |
| | electricity | |
| Means of Distributing | Copper | Pipes, Tanks |
| Carrier | | |
| Dispatchable Power | Heat Engine | Heat Engine |
| Supply | | |
| Primary Source of | Heat Engine | Heat Engine |
| Energy Loss | (Carnot) | (Carnot) |
| Marginal Cost of Use | Hydrocarbon | “Liquid fuel” |
| | | (Hydrocarbon) |
| Chemical Discharge | N₂, H₂O, CO₂ | N₂, H₂O, CO₂ |
| | (atm.) | (atm.) |
| Discharge Location | Outside of home | Behind vehicle |

Over a century later, despite the risks of climate change, despite the implications of foreign oil dependence, and despite the costs of local pollution (respiratory, visual, noise, and smell), these energy systems continue to dominate in every developed country in the world.

The reason for lack of progress is that, for any emissions free capacity resource, additional capital investment is required for the fuel. For example, additional capital is required upfront for the infrastructure for the nuclear reactor, solar field, geothermal, or “Carbon Capture” infrastructure. This additional capital investment is problematic with low utilization: the capital-intensive fuel source must also idle, leading to a wasted investment.

Electricity storage has long been proposed as a solution dating back to the days of Henry Ford. However, the essence of what makes storage efficient is what makes it both heavy and capital intensive: the extensive use of solid components (metal). By using all solids, energy shifts do not result in chemical reactions which give off heat (condensing/compression/reduction). Therefore, heat creation is largely avoided, and efficiency is maximized.

The trade-off of efficiency is the capital-intensity of solids (metals). If storage avoids chemical changes through capital intensity, it will inherently suffer economically when used to store energy over long durations. In the electricity sector, long duration storage is defined as weeks to months rather than hours and days. For transportation, long duration storage is defined as a range of hundreds of miles after a ˜5-minute fill-up rather than tens of miles.

Regardless of sector, electric or transportation, efficient long duration storage inherently implies infrequent use of a capital intense asset—emissions free power plants, batteries, or both. The essence of decarbonization is inventing a chemical energy distribution system which improves upon the Edison/Ford distribution systems. Underutilized capacity has a cost in the range of ˜$1,000/kW while energy inefficiency is largely contained to the heat engine's “Carnot” losses. Though very competitive, there is room for improvement.

### SUMMARY

Thermal Hydrogen is an improvement in 1) emissions free dispatchable power, 2) emissions free chemical energy storage, and 3) emissions free chemical energy distribution. Each of these improvements is accomplished using a distinct invention, but each invention uses a similar, “thermo-chemical”, or Thermal Hydrogen strategy.

The “thermo-chemical” strategy is to use excess heat (and/or electricity) to help fuel a chemical splitting process. The thermal side of Thermal Hydrogen improves capital utilization and energy efficiency by pairing excess heat with demand. If excess heat can be united with heat demand, then the system can be just as efficient as a solid (metal) storage system because heat is not “lost” to the atmosphere. Heat is simply moved to demand, or demand is moved to it.

The chemical strategy of Thermal Hydrogen is to maximize the value of the thermal process by maximizing every chemical of the supply chain. The first chemical of the split provides hydrogen supply or enables a hydrogen carrier. The second chemical of the split is pure oxygen. Pure oxygen provides additional value by enabling a pathway for hydrocarbons to be utilized emissions free and without “Carbon Capture”.

Oxidizing hydrocarbons with pure oxygen prevents nitrogen from being the dominant chemical in hydrocarbon oxidation products. When a hydrocarbon is combusted with atmospheric oxygen, the vast majority of the products, ˜80%, are nitrogen.

For hydrocarbons to be emissions free without Thermal Hydrogen, the presence of nitrogen must be removed at some point from the reaction. After the nitrogen is removed, only CO₂ and water remain, which are easily separable. The isolated CO₂ is then compressed to a liquid and stored underground.

The process of separating the nitrogen is called “Carbon Capture”, and it makes up the vast majority of the costs of Carbon Capture and Sequestration (CCS). The nitrogen can be removed before combustion (pre-combustion CCS) or it can be removed after combustion (post-combustion CCS). Regardless, pure nitrogen exits the system to the atmosphere. This results in wasted energy when nitrogen re-mixes with the air known as the entropy of mixing.

Table 2 below quantifies the minimum energy required to isolate one mol of CO₂ from air, the flue gas of a hydrocarbon process, and a Thermal Hydrogen process. The energy required increases exponentially as concentration of CO₂ decreases. If pure oxygen can be made available, the products of oxidation are limited to CO₂ and H₂O, which are easily separable. Thus, there is very little capital or energy required to separate nitrogen. The CO₂ of the reaction is referred to as “sequestration ready”.

TABLE 2
The energy required to separate one mol of CO₂ from a mixture

| | Energy to separate CO2 | |
|---|---|---|
| | from a mixture | |
| Direct Air Capture (Separating | ~22,500 | J/mol |
| CO2 from atmosphere) | | CO2 |
| Carbon Capture (Separating | ~7,500 | J/mol |
| CO2 from flue gas) | | CO2 |
| Pure Oxygen Provided | ~0 | J/mol |
| (Thermal Hydrogen) | | CO2 |

The other benefit of using pure oxygen for hydrocarbon oxidation is that simpler, more efficient thermodynamic cycles can be used. Pure oxygen enables simpler more efficient systems because the removal of nitrogen allows more direct heat use (steam as a thermal medium can be removed).

For electricity production, the Allam cycle, using supercritical CO₂, can be utilized rather than a combined Brayton and steam cycle. For hydrogen or syngas production, auto-thermal reforming can be used rather than steam methane reforming.

Overall, by using simpler, more efficient cycles and by yielding only “sequestration ready” CO₂, hydrocarbons can become increasingly competitive without emissions. Thus, hydrocarbons provide value for pure oxygen, and thus the “thermo-chemical split”, particularly if CO₂ sequestration is valued.

In Table 3 below, the three different improvements are listed. The “thermo-chemical” device is the device which splits chemicals in part by using excess heat (and/or electricity). The first chemical either supplies hydrogen or a hydrogen carrier. The oxygen is then used to enable hydrocarbons as an emissions free energy supplier and carrier. The improvement in the system-whether the improvement was in capital utilization, energy efficiency, or both, is listed in the last column.

TABLE 3
Thermal Hydrogen Systems, “Thermo-chemical”
Devices, and their Improvements

| | Thermo- | Hidden | | | | |
|---|---|---|---|---|---|---|
| Thermal | chemical | Heat | First | | Second | System |
| Hydrogen: | Device | Quality | Chem. | Purpose | Chem. | Improvement |
| Supply | Electrolyser | Heat | H₂/CO | Supply | O₂ | Capital |
| | | (Endo) | | | | Utilization |
| Storage | Air Separation | Cooling | N₂ | H₂ | O₂ | Capital |
| | Unit (ASU) | | | Carrier | | Utilization & |
| | | | | | | Efficiency |
| Distribution | Solid Oxide | Heat | H₂/CO | H₂ | O₂ | Efficiency |
| | Fuel Cell | (Exo) | | Carrier | | |
| | (SOFC) | | | | | |

The “thermo-chemical” devices provide a pathway that is either an improvement in capital utilization or energy efficiency, or a mixture of both. As a result, the capital and efficiency redundancy thought to be inherent to emissions free energy distribution can be minimized or avoided:
1) Capital (or heat) investment lost due to idling of emissions free infrastructure (batteries, nuclear, solar, wind, geothermal, etc.).
2) Gas separation (“Carbon Capture”) or any venting of pure chemicals
3) Gas compression for liquid storage and distribution

The achievements listed above are made possible by the uniting three different, mutually reinforcing, Thermal Hydrogen systems, as described below.

### 1) Thermal Hydrogen Supply: An Improvement in Emissions Free Dispatchable Electricity

For a dispatchable heat engine to become emissions free, some sort of additional capital cost is required for the fuel—either a nuclear reactor, a solar field, or “Carbon Capture” equipment. Without alternate energy carriers, idling the heat engine will result in idling the capital-intensive investment of the fuel infrastructure as well.

The Thermal Hydrogen supply system provides the effect of emissions free, dispatchable electricity supply but without idling capital intensive capacity. Instead, it idles the operation of less-capital intensive capacity to provide the effect of a dispatchable, emissions free power plant.

Furthermore, by bypassing Carnot losses and using the endo-thermic nature of electrolysis, the system can do so without sacrificing energy efficiency. The object of this invention could be described as an emissions free power plant, available on demand, which may produce electricity less than or equal to 50% of the time yet remain commercially viable.

The Thermal Hydrogen supply can be an energy system comprising an electricity power plant, an electrolyser, and oxidation of hydrocarbons by the oxygen from that electrolyser. Advantageously, the fuel source has the option to divert fuel use to chemical commodities rather than having a fuel source totally dedicated to an electric power plant.

In other words, the emissions free fuel can have a profitable opportunity, regardless of electricity prices, because of the opportunity to produce multiple valued chemicals. The revenue of the chemicals can help pay off the fuel source, allowing it to be profitable enough to be ready to produce electricity, on demand, even if it's not actually utilized very often.

The option to dispatch from electricity to chemical sectors prevents the emission free resource from idling. The times when an emissions free heat engine would idle are the same times when an electrolyser would be most profitable.

An objective can be to increase the utilization of capital intense capacity. An electrolyser has a capital cost of approximately ˜$400/kW compared to a heat engine at ˜$1000/kW. So, instead of idling the capital cost of the entire nuclear plant ($5,500/kW), only the engine (˜$1000/kW) or electrolyser ($400/kW) idles.

Another objective of minimizing heat “loss” can also be accomplished. Heat assisted electrolysis is endothermic, and if heat is available at a temperature of around 1000° C., electrolysis can be powered by equal parts heat and electricity.

From the perspective of the heat source, electrolysis is an improvement because it is 75% efficient. For the electricity coming in off the grid, it loses 25%. So, the gain and loss in energy cancel each other out. Overall, because Carnot is avoided, the process loses about the same amount of energy as the heat engine. The system is 75% efficient, but it also doubles in size by purchasing grid electricity.

With the effect of dispatchable electricity provided with similar efficiency, the commercial viability of the additional capital cost, the electrolyser, can still be warranted by the value of the chemicals. In the storage and distribution sections below, I show how to maximize the value of the first chemical given off by H₂O or CO₂ electrolysis—hydrogen (H₂) or syngas (H₂/CO). In this section, I'll focus on how the value of oxygen is maximized.

Partial oxidation of hydrocarbons is used to provide consistent value for the pure oxygen supplied by electrolysis. As the name suggests, partial oxidation requires less oxygen than full oxidation, and the productivity of partial oxidation helps the oxygen provide value.

By using the oxygen from electrolysis, auto-thermal reforming of methane can provide three to eight times as much hydrogen or syngas, respectively, as the electrolyser. Therefore, if all the electrolysers' oxygen were used for partial oxidation, the vast majority of the chemical energy from that combined process would be hydrocarbon based.

Given the productivity of oxygen when used for partial oxidation, it is unlikely that oxygen from electrolysis will be used exclusively for oxy-fueled power plants. Oxy-fueled power plants require full oxidation, higher capital costs, and suffer from Carnot losses. Furthermore, oxygen would have to be stored on longer timescales.

However, part of the benefit of a reservoir of oxygen is the ability to occasionally dip into this reservoir when the market warrants. Oxygen will be more valuable with higher electricity prices. The additional spikes in demand for oxygen adds value which encourages more oxygen supply.

Assuming the value of oxygen increases with demand for electricity, the reformers may idle due to excessive oxygen demand. This is acceptable because it would make way for oxygen supply for the electricity sector, decreasing the likelihood that oxygen supply would run out.

Reformers have the lowest capital costs of all assets in the system—approximately $200/kW—and the ease of storing chemical energy carriers as liquids, as discussed below, means they can be oversized to accommodate oxygen. Even if an electrolyser is idling due to high electricity prices, and a reformer also idles due to high oxygen prices, together their capacity costs would add up to approximately $600/kW. That is still less than the cost of idling a heat engine at approximately $1,000/kW

The location of the oxyfueled power plant is another feature of this system. The oxyfuel power plant may be located where power plant prices are highest. In some embodiments of the system, an oxygen pipeline moves oxygen from supply to demand. This oxygen may be kept safe by insulating it with the CO₂ that the oxygen will create. Should an oxygen pipeline leak, it would leak into the CO₂ pipeline. Should the oxygen pipelines explode, the surrounding CO₂ pipeline would also explode, and the CO₂ would retard combustion.

Another possible use for the oxyfuel heat source is to hybridize it with a nuclear, solar, or geothermal power plant. For example, if a solar thermal power plant has a heat engine, the heat engine would likely have a low utilization rate due to the infrequency of solar, particularly during the winter season. Oxyfuel hybridization with this heat engine would enable the turbine to provide on demand capacity yet use the solar resource when available.

To review, the Thermal Hydrogen Supply invention is an improvement because it can provide dispatchable, emissions free power without idling capital-intensive infrastructure. Furthermore, if heat-assisted electrolysis is used, there is no net heat “lost” to the atmosphere compared to the operation of a heat engine. Finally, the use of oxygen further increases system value by enabling simpler, thermodynamic processes which do not require “Carbon Capture”.

### 2) Thermal Hydrogen Storage: An Improvement in Emissions Free Chemical Energy Storage

The supply portion of Thermal Hydrogen supplies the foundational chemicals for the system: H₂, CO, and O₂. The storage portion of Thermal Hydrogen adds to this foundation by enabling some or all chemicals to be stored and distributed as liquids. Furthermore, this is accomplished in a way that minimizes the largest capital and energy expenditure of storing and moving chemicals: gas compression.

The Thermal Hydrogen storage system uses the H₂, CO, and O₂ from Thermal Hydrogen supply, and along with a supply of electricity, air, water, and hydrocarbons, converts at least some of these energy resources and carriers to low pressure liquid chemicals ready for storage, distribution, or sequestration: NH₃, CH₃OH, O₂, and CO₂. Advantageously, chemicals leaving the system can be in liquid form at atmospheric temperature without substantial direct gas compression to get to that state.

The system can comprise an air separation unit, a hydrocarbon reformer, a methanol reformer, the Haber-Bosch process, the water gas shift reaction, cold and hot heat exchangers, a small CO₂ compressor, pumps, and tanks. The combination of these technologies allows all chemicals to be stored and distributed with minimal heat “lost” to the atmosphere, without any pure chemicals wasted, and with minimal gas compression of chemicals.

The technology begins with a “thermo-chemical” split—an air separation unit (ASU). An ASU is effectively an industrial scale air conditioner. A compressor is used to cool air until the oxygen liquifies which occurs at −183° C. When the oxygen liquifies, it is separated from nitrogen.

Creating oxygen in a cold, liquid state enables it to be stored at the lowest cost, as a liquid, in an insulated tank rather than a pressurized tank. Creating oxygen consistently, then storing for longer time scales is particularly useful to Thermal Hydrogen because it would balance the intermittent nature with which electrolysers would supply oxygen and oxyfuel turbines demand it.

The ASU is also used to create pure nitrogen for the Haber Bosch process, which allows the nitrogen and hydrogen to reform to ammonia (NH₃) over a catalyst. One source of pure hydrogen for the Haber Bosch process is the water gas shift reaction, which reforms syngas (CO) to hydrogen. A second source of pure hydrogen is partial oxidation of hydrocarbons using the pure oxygen from electrolysis (or the ASU).

The water gas shift reaction and partial oxidation of hydrocarbons may also be used to create syngas with a desirable ratio of H₂ to CO. If there are two hydrogen molecules for every one carbon monoxide molecule, they may reduce to methanol (CH₃OH) over a catalyst. Methanol can be stored and distributed like gasoline, so unlike ammonia, and oxygen, it can be stored at atmospheric temperature and pressure as a liquid. In the next section on distribution, I'll describe how this methanol can be distributed emissions free.

Three reactions mentioned above (WGS, methanol reforming, and Haber-Bosch) are all mildly exothermic. The temperature of the heat from these processes is not high enough to perform steam methane reforming, but they can perform “internal reforming” or augment the production of auto-thermal reforming. Therefore, though chemicals are reduced into pumpable chemicals through gas condensing, the heat is not “lost” due to the endothermic nature of hydrocarbon reforming. If more practical, this waste heat could also be used for heat assisted electrolysis.

The primary thermal advantage of the storage system is waste cooling from the ASU which can also be utilized to eliminate or decrease compressor work.

The nitrogen leaving the ASU is approximately ˜−183° C. Instead of compression, cooling from the ASU can help ammonia and/or CO₂ towards liquid condensation.

Before being used for the Haber-Bosch process, nitrogen from the ASU can be used to cool the ammonia leaving the Haber-Bosch process. Ammonia condenses to a liquid at −33° C. and atmospheric pressure. After the ammonia is cool enough to liquify, it can be stored as a low-pressure liquid, which can be preferable, economically, to large scale pressurized ammonia storage.

The CO₂ exiting partial oxidation may be pressurized for sequestration. CO₂ changes phase directly from gas to solid at very low temperatures (−50° C.). Accordingly, CO₂ may be cooled to nearly this point before it is compressed to a liquid, thus reducing the compressor work necessary.

Normally, this waste cooling from an ASU is used to pre-cool incoming air. This is still the intention with this improvement, thus the cooling is not wasted. When the cold, liquid fluids above (CO₂, NH₃, or O₂) leave the system, they are pumped as cold liquids up to a higher pressure. Unlike a gas, compressing a fluid does not change its temperature significantly.

Fluids can then be pumped up to a higher pressure so that they can still remain fluids after they lose their cooling potential to the incoming air. Effectively, the waste cooling from the ASU enables oxygen storage, ammonia storage and distribution, as well as CO₂ condensing—all with the minimal use of compressor. Then, just as in Ford's system, these low or atmospheric pressure liquid fluids can be distributed pragmatically to load.

In theory, the only heat “lost” in this entire system can be the air which needed to be compressed for the Air Separation Unit. The heat given off by the exothermic reforming processes (WGS, etc.) can be utilized to assist hydrocarbon reforming or electrolysis. Auto-thermal reforming of hydrocarbons is neither exothermic or endothermic, as its name suggests. The fluids which needed to be pumped up to pressure for distribution, can be cooled to minimize the need for gas compression. Then that cooling can be re-captured by the incoming air.

The ASU can be excessively capital intensive and energy inefficient; however, pure oxygen makes hydrocarbon processes simpler and more compact. In fact, as CO₂ turbines are smaller and more efficient than steam turbines, the capital expense and inefficiency associated with the ASU can be made up for by reduced compressor infrastructure and energy losses elsewhere.

The Thermal Hydrogen storage process can be thought of as the replacement for oil refineries—it's a modern chemical plant. Fossil fuels, regardless of application, need some form of refining or reforming, and this facility provides it with increasing convenience because every chemical can be stored and distributed as a liquid.

In some embodiments, the alternative method for creating pure nitrogen could be to burn hydrogen (or ammonia) with atmospheric air and then recollect the products. The products would be water and nitrogen, which are easily separable, isolating a new source of nitrogen. The nitrogen can then be transported to the Thermal Hydrogen Storage facility to make ammonia. The advantage would be the production of pure nitrogen by locally burned hydrogen. The nitrogen could then enable ammonia production, which is easier to store for longer periods of time and easier to distribute longer distances. The embodiment described above, however, is preferable to this option for its supply of oxygen which is easily storable as well as the usefulness of the cooling of the ASU.

Furthermore, some embodiments may also use the cold oxygen for cooling CO₂ and ammonia in addition to or instead of the cold nitrogen leasing the ASU. However, the embodiment outlined above is preferred due to more consistent envisioned operation of the reformers, which require constant CO₂ sequestration, than distribution of O₂.

### 3) Thermal Hydrogen Distribution: An Improvement in Emissions Free Chemical Energy Distribution

In the Thermal Hydrogen Storage system, O₂, NH₃, and CH₃OH can be created in a way so that they can be stored and then distributed pragmatically as liquids. The oxygen created by the ASU, which can be directly stored at low temperature, can buffer the intermittent supply of oxygen (supply from electrolysis vs. demand to oxyfuel power plants). The NH₃ can be distributed to replace the services provided by hydrocarbon combustion.

In the Thermal Hydrogen distribution system, methanol (CH₃OH) is used as a hydrogen carrier intended for use in fuel cells. Solid oxide fuel cells (SOFC's) provide the “thermo-chemical” process—utilizing waste heat to create new chemicals intended to ease the distribution of hydrogen as well as the oxygen to enable emissions free utilization of hydrocarbons.

A small amount of waste heat from the SOFC is used to reform the methanol back into syngas. The syngas is then used to fuel the SOFC. The oxidation of hydrocarbons in these types of fuel cells do not result in any nitrogen in the products. In SOFC's, oxygen ions cross the electrolyte rather than hydrogen ions—the products of oxidation are limited to CO₂ and H₂O.

The effect is an oxidation process which at the same time filters atmospheric oxygen from nitrogen. Thus, SOFC's, like electrolysers, provide a source of pure oxygen supply through electrolyte filtration which allows hydrocarbon oxidation without the need for “Carbon Capture”.

It is assumed that a combination of batteries and fuel cells provide portable power for transportation. Methanol is distributed from the Thermal Hydrogen Storage facility to fuel cells similarly to gasoline. The methanol is used in the SOFC as described above, and the CO₂, and possibly also the water, are stored by the automobile on-board.

The CO₂ (and possibly) the water can then be returned to the gas station when the automobile refuels with methanol. The gas station can either return the CO₂ (and water) to the CO₂ sequestration network through a pipeline, or it can return it by using another truck. Logically, instead of the methanol truck returning from the gas station with an empty tank, the methanol truck can collect the CO₂ (and water) from the gas stations, and transfer it to the CO₂ sequestration network.

Advantageously, the system avoids the issues of distributing hydrogen.

SOFC's can reach up to 900° C. and therefore can produce the heat necessary to reform methanol.

It should also be mentioned that the CO₂ can be pressurized back into a liquid for sequestration. This can occur in the car, at the gas station, or at the distribution center where the methanol truck exchanges carbonated water for methanol. Factors in such an arrangement can depend on the size and weight constraints of cars, gas stations, or methanol trucks.

In some arrangements and methods, the hot CO₂/H₂O is used it to pre-heat the incoming air to the SOFC. Advantageously, this can reduce the temperature of the CO₂/H₂O. After the temperature is decreased by incoming cooling air, the compression work can be minimized since the gas would be closer to atmospheric temperature.

The car may have a large enough CO₂ tank so that the CO₂ could be kept on board as a gas rather than a liquid. Logically, the more time the CO₂ is on board, the more heat may be transferred to atmosphere. Then, the car may plug into an outlet at home or at a gas station which could compress the CO₂ to a higher pressure, possibly to liquid form.

Should it be feasible to return the CO₂ all the way back to the CO₂ sequestration network as a gas, the work of compression could be largely avoided by the waste cooling ammonia. If ammonia from the Thermal Hydrogen storage system is distributed to local distribution centers as a liquid, the location where this liquid expands into a gas will create a gas that's approximately −30° C. Utilizing this cooling would reduce most of the work required to compress the CO₂ to liquid form.

In some embodiments, it might be useful to attempt to store the heat from the SOFC on board rather than exhaust it for compression. For example, if a CO₂ tank in the car is large and thermally insulated, the heat could be stored for later use. This could occur because the car switched back to electric power. This could also occur because the car arrives at home.

When the car arrives at its destination, an insulated hose could transfer the heat of the tank to the house. This provides the advantage of using the waste heat as well as the advantage of compressing the CO₂ after its been given a chance to cool to room temperature.

Finally, the recollection of CO₂ presents the opportunity to recollect H₂O as well. The water could be recycled if filtered, or it could be kept within the energy system for use elsewhere. Hydrocarbon reforming requires substantial water demand. Furthermore, an abundant source of water would increase the efficiency of thermal power plants. Given the pipeline infrastructure required for the above system and the amount of water produced by SOFC's, this water could provide substantial value to an industry which sometimes suffers from water scarcity.

Further forms, objects, features, aspects, benefits, advantages, and embodiments of the present invention will become apparent from a detailed description and drawings provided herewith.

### BRIEF DESCRIPTION OF THE DRAWINGS

FIG. 1 illustrates the broadest view of the Thermal Hydrogen energy systems and how all three Thermal Hydrogen concepts, supply, storage, and distribution, are related.

FIG. 2 illustrates an embodiment of the Thermal Hydrogen supply system using heat assisted electrolysis and a heat engine in order to provide the effect of dispatchable electricity supply as well as a supply of chemical energy carriers and oxygen.

FIG. 3 illustrates an oxyfueled embodiment of the Thermal Hydrogen system which shows hydrocarbons as the emissions free fuel which may dispatch an oxyfueled turbine based upon the price of the grid.

FIG. 4 illustrates a Thermal Hydrogen storage system.

FIG. 5 illustrates a Thermal Hydrogen distribution system.

FIG. 6 illustrates a method and system during a period of excess electricity supply on the grid.

FIG. 7 illustrates a method and system during a period of deficient electricity supply on the grid.

### DESCRIPTION OF THE ILLUSTRATED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The essence of meeting energy services is providing a distribution system from supply to demand. Due to the incongruence of supply and demand, both temporally and spatially, it is necessary to engineer a distribution system which satisfies both dimensions.

Hydrocarbon energy suppliers and carriers have served the purposed of solving both temporal and spatial problems for over a century. Hydrocarbons were stored millions of years ago, and given that carbon is the most versatile element in the universe, it should be no surprise that hydrocarbons are abundant and come in different phases: as a solid, gas, or liquid.

Between the ability to store solid hydrocarbons at power plants, or pipe gaseous/liquid hydrocarbons to power plants, or pump liquid hydrocarbons to portable power plants, the task of meeting energy services is met in both dimensions—temporal (time) and spatial (space).

The challenge of decarbonization is overcoming the temporal and spatial and temporal challenges of distribution without using the versatility of hydrocarbon atmospheric oxidation—or paying the price of gas separation through Carbon Capture and Sequestration.

The energy system proposed here suggests that underutilized capacity is inevitable somewhere in the system at some time simply due to the lack of coincidence between supply and electricity demand on temporal basis.

Secondly, Thermal Hydrogen suggests that inefficiency is inevitable somewhere in the system at some time simply due to thermodynamics. Given that some energy supplier will utilize a heat engine, significant energy losses are inevitable. If Carnot is to be avoided, for instance by using an electrolyser/reformer and then using a fuel cell, energy is lost due to the extra processes involved.

The Thermal Hydrogen system acknowledges that decarbonization implies increasing capital intensity—either through use of fewer hydrocarbons or by use of Carbon Capture and Sequestration. Some of this excess capital intensity will be in the form of heat—such as nuclear decay, excess solar energy, geothermal energy, etc.

However, increasing capital intensity does not necessarily mean increasing costs. Renewables and fossil fuels may have the same “levelized” costs. However, if the energy service at hand is dispatchable electricity, that is a service not yet offered by cheap renewables. The key is to take advantage of more capital intense energy suppliers without taking on a problem of low utilization or inefficiency.

Rather than trying to engineer an energy system without any waste energy or excess capacity, the Thermal Hydrogen system simply seeks to improve upon the current system. With the current fossil based system, the cost of excessive capital intensity is in the arena of ˜$1,000/kW.

Furthermore, with the current fossil based system, the cost of inefficiency is in the heat engines, meaning that about half the heat or more is lost in the condenser (Carnot losses). Finally, fossils currently use steam cycles for both electricity and hydrogen production. This provides additional room for improvement as pure oxygen fueled cycles do not require steam as an intermediate thermal medium.

Therefore, the current system can be improved upon by providing the effect of dispatchable capacity through dispatchable supply as well as dispatchable demand. The devices which will be underutilized in order to provide the effect all have costs approximately half of a heat engine. Therefore, the temporal problem of distribution, underutilization of capacity, is absorbed by something less capital intense—an electrolyser—rather than by something that is more capital intense—a nuclear reactor.

So, while additional steps are required by these process, each of these steps is less capital intensive and more energy efficient. It is possible for these steps to become more energy efficient because they use multiple, efficient steps rather than fewer, less efficient steps. Electrolytes are used instead of pneumatics, allowing an escape from Carnot losses of heat engine.

One may argue that these additional steps will result in heat loss at the point of supply, storage, or distribution due to the inevitable nature of chemical energy carriers to give off waste heat due to chemical reduction/compression/condensing. However, the Thermal Hydrogen pairs heat demand with excess heat at every point of the process: supply, storage, and distribution. Therefore, minimal heat is “lost” to the atmosphere.

Thus, the energy system does not completely rid emissions free energy of either capital intensity or inefficiency. However, underutilized capacity is limited to $1000/kW and energy losses are limited to Carnot or less.

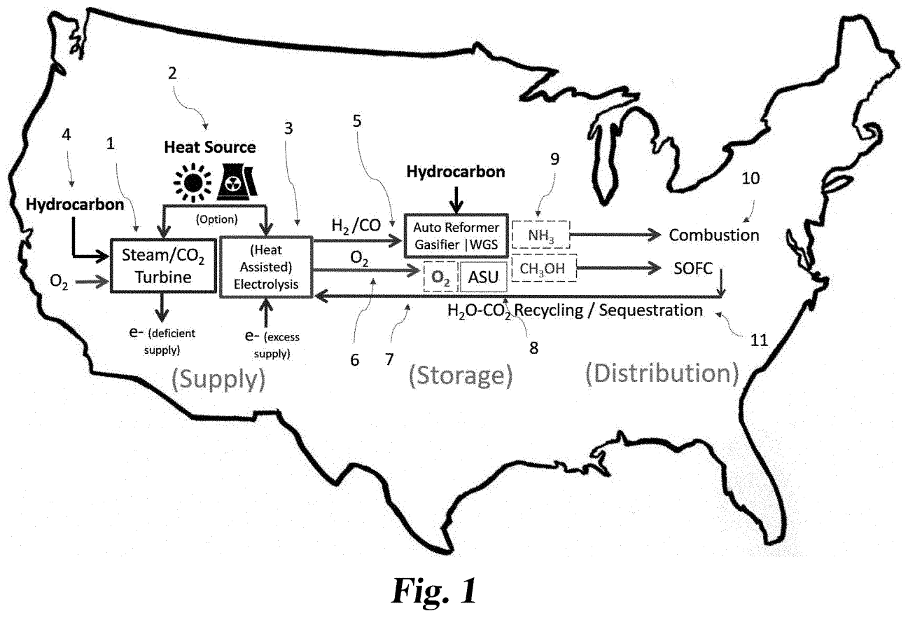

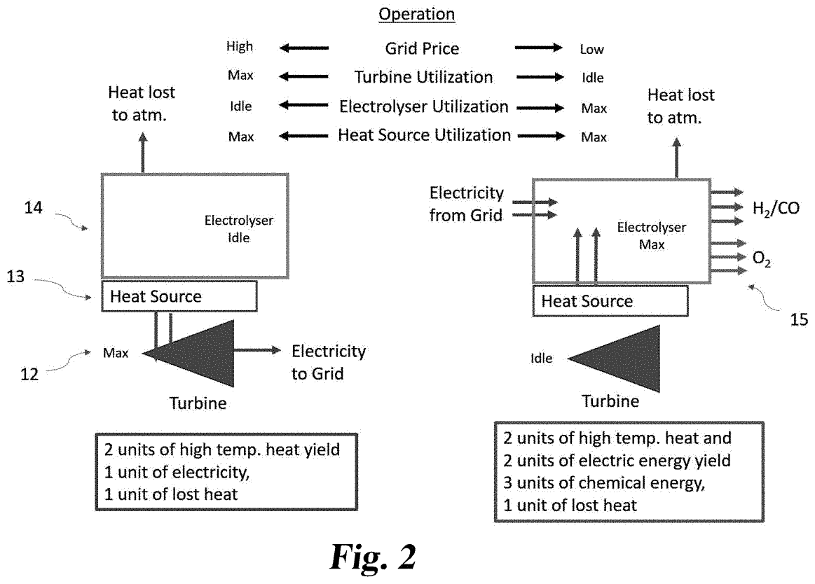

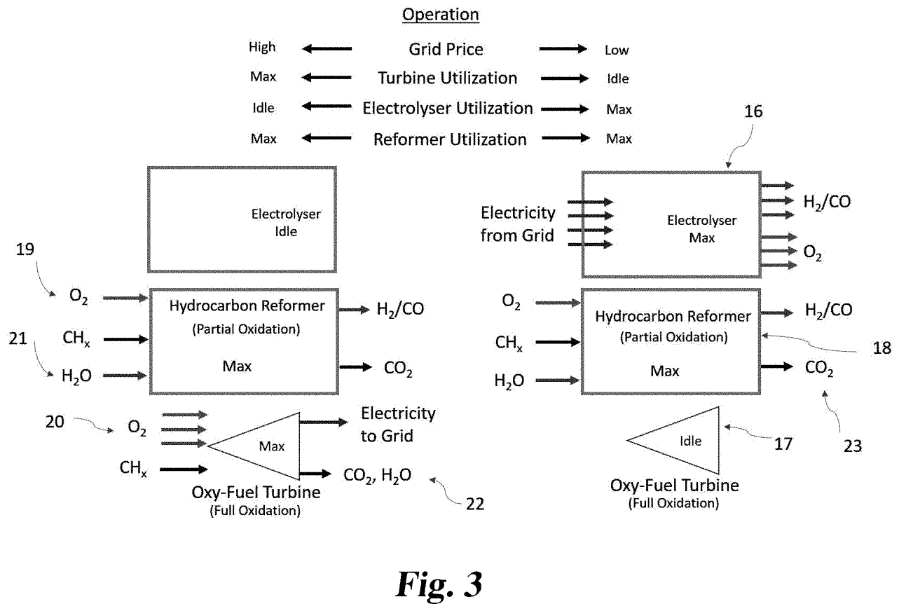

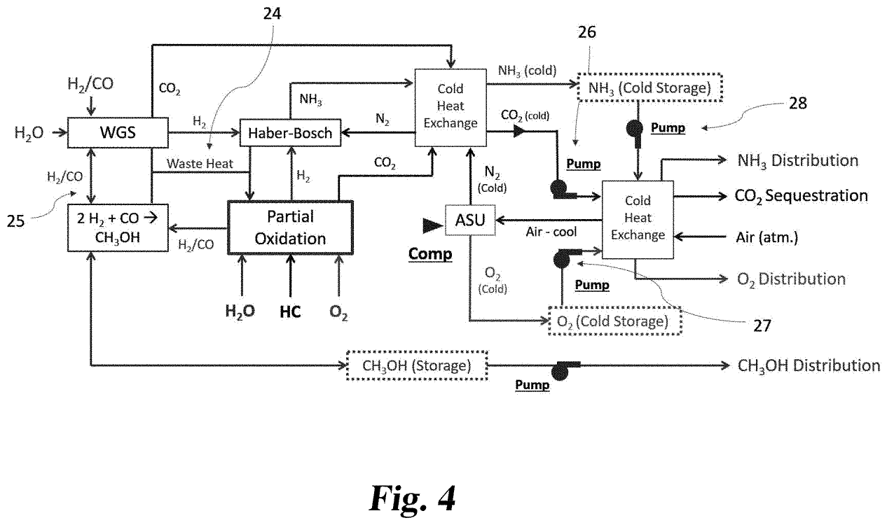

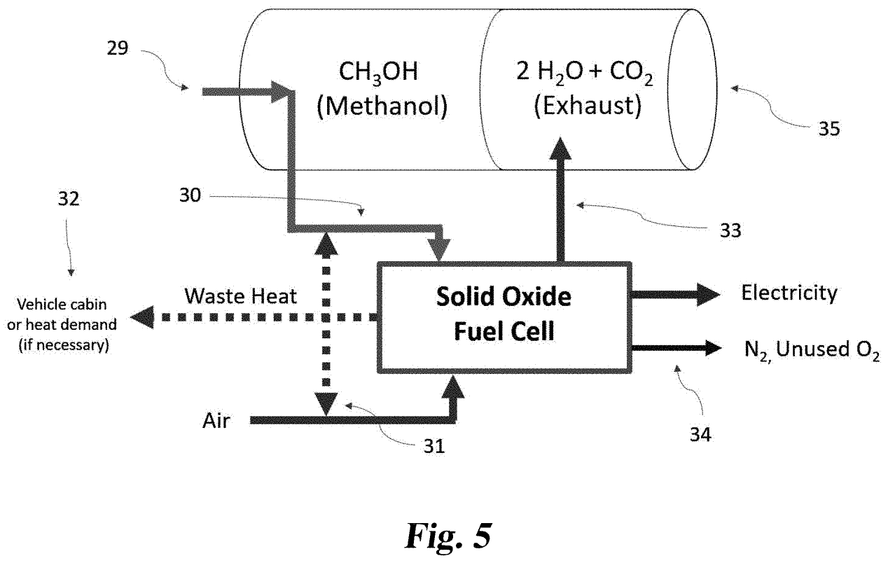

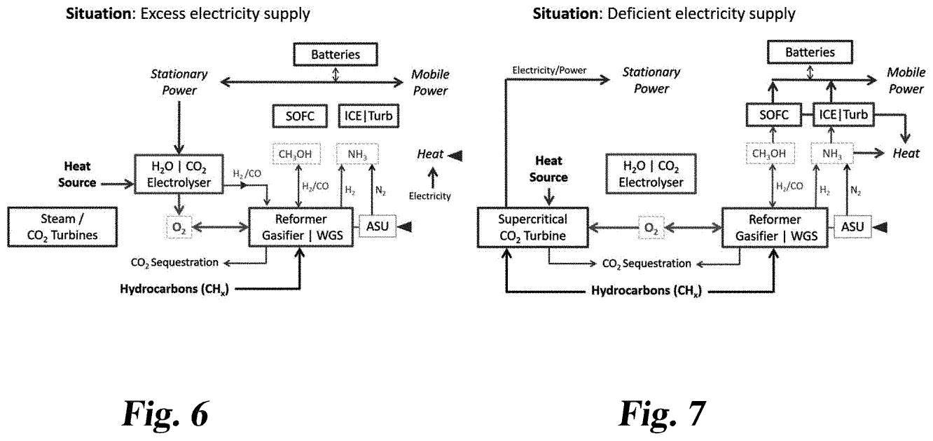

FIG. 1 illustrates all three of the Thermal Hydrogen energy systems with the broadest view possible. From the left side of the figure to the right, the supply, storage, and distribution systems of Thermal Hydrogen are shown. The supply system is shown in more detail in FIGS. 2 and 3, the storage system is shown in more detail in FIG. 4, and the distribution system is shown in more detail in FIG. 5.

The Thermal Hydrogen supply system consists of three different technologies an electrical power plant (1), a heat source (2), and an electrolyser (3). These three technologies work together to provide the effect of emissions free, dispatchable electricity without underutilized capital-intensive capacity.

The heat source (2), which typically has by far the highest capital cost, is intended to maintain full utilization regardless of demand for electricity. During times of deficient electricity supply on the grid, the power plant (1) produces electricity. The power plant may be fueled by the heat source (2), or by the hydrocarbon and O₂ (4).

These systems are shown here on the same power block, but these power plants may not be co-located to take advantage of the portability of oxygen and hydrocarbons which may garner higher electricity prices if piped towards electricity transmission constraints.

During times of excessive electricity supply on the grid, the heat source directs its heat towards the electrolyser (3). The electrolyser provides the service of dispatchable demand by purchasing electricity from the grid. However, heat is not necessarily “lost” during this process if heat-assisted electrolysis is utilized due to the endothermic nature of electrolysis.

Therefore, the supply system accomplishes similar efficiency loss as a heat engine, but enables the heat source to provide the effect of dispatchable supply without underutilization of capital-intensive capacity.

The products of electrolysis are piped either directly to demand, or towards the Thermal Hydrogen Storage system as shown in the figure. Electrolysis may produce either H₂ or CO (carbon monoxide). If necessary, this is the only time gases are piped in the entire system (with the exception of ammonia delivery). All other chemicals can be distributed as pumpable fluids: oxygen, ammonia, methanol, and CO₂.

Because of the pumpability of the chemical energy carriers utilized, the Thermal Hydrogen storage system can be located either close to supply or closer to distribution. If the facility is located closer to supply, the advantage is less syngas and oxygen piping. The former requires a compressor whereas the latter introduces a risk due to the flammability of oxygen. An embodiment of the pipelines of O₂ (6) and CO₂ (7) provides insulation to the oxygen by wrapping the oxygen in a chemical which retards combustion.

If oxygen piping hurdles can be overcome, the Thermal Hydrogen Storage facility can be located closer to demand. In this instance, hydrogen could be distributed rather than hydrogen carriers with the minimum distance required.

The Thermal Hydrogen storage system converts the products of electrolysis and hydrocarbons, to pumpable, distributable chemical energy carriers. This energy system has the least capital-intensive components of the whole system and also features the least heat losses of the energy system. This system could be thought of as the modern equivalent of an oil refinery—through efficiency and low capital intensity, it has a minor impact on system costs.

The waste heat of all exothermic processes (WGS, Haber-Bosch, methanol reforming) is utilized to assist reforming. Compressing of any gases to liquid is prevented by using the waste cooling from the air separation unit (8). Ammonia (9), methanol, and oxygen are all stored as cold liquids from the waste cooling of the air separation unit. After achieving liquid form, these chemicals are pumped to distribution pressure, and before leaving the system their cooling is used to pre-cool the incoming air to the ASU.

The fluids are then piped to the Thermal Hydrogen distribution system. At the distribution system, ammonia is distributed to applications where atmospheric combustion is desired (10). The methanol is piped to solid oxide fuel cells where the carbonated water is recollected and then piped back (11).

As shown from this very broad view, each component of the energy system is mutually reinforcing. The effect of dispatchable electricity is provided without idling any capital intense capacity. Energy is stored and distributed to load as a pumpable fluid without any single significant process causing substantial heat loss. Therefore, the system offers a balance of capital intensity and energy efficiency similar to that of the modern energy system which relies on dispatchable heat engines.

FIG. 2 illustrates the first embodiment of the Thermal Hydrogen supply system. It consists of a heat engine (12), a heat source (13), and heat assisted electrolysis (14). Not shown in the figure is the use of the oxygen (15), and this will be discussed in FIG. 4 below.

This combination of devices in operated in a way to provide the effect of dispatchable supply but without underutilizing the most capital-intensive component.

This figure is intended to be illustrative of the energy balance occurring with different operation modes. The system on the left, where the turbine is engaged, has two units of heat energy input as indicted by the arrows. Assuming this is a high temperature source, this engine would produce one unit of electricity and lose one unit of heat to the atmosphere.

The figure on the right side shows the heat source being re-directed towards the electrolyser. Then, electricity input from the grid augments this heat supply. The electrolyser is ˜75% efficient whereas the turbine is only ˜50% efficient. However, both systems result in the same amount of heat going to the atmosphere, and the same amount of net energy being produced—either one unit of electricity or one net unit of chemical energy.

Given that the net production of each pathway is the same, it's a matter of the value of the chemicals vs. the value of electricity. However, the production of oxygen increases the value of electrolysis. The value of oxygen provides an additional revenue stream for electrolysis. Between the efficiency of electrolysis and the value of chemical energy carriers and oxygen, the electrolyser can justify its capital costs.

FIG. 3 illustrates the oxyfuel embodiment of the Thermal Hydrogen supply system. It consists of an electrolyser (16), turbine (17), and some sort of partial oxidation (18) process which produces chemical energy carriers.

Whereas FIG. 2 showed the approximate energy intensity of each process by using a proportional number of arrows, this system attempts to convey the oxygen intensity of each hydrocarbon process (19) and (20).

As the name suggest, partial oxidation, reforming hydrocarbons to chemical energy carriers, requires far less oxygen than does full oxidation, fully reducing hydrocarbons to water and carbon dioxide. As shown in the figure, partial oxidation utilizes water (21) to provide oxygen and hydrogen where as full oxidation produces water.

This is an important observation due to the limited supply of oxygen. This embodiment attempts to do the same thing as the previous embodiment—provide dispatchable electricity without underutilized capital intense infrastructure. This made possible by using an oxy-fueled turbine which does not require “Carbon Capture”.

However, the supply of oxygen is finite and the opportunities to use the oxygen for oxyfuel turbines occurs at different times than the supply of oxygen. The use of partial oxidation enables a constant value for oxygen because there will almost always be a value for chemical energy carriers.

The constant value for oxygen provided by partial oxidation provides the reservoir of oxygen for the oxyfuel turbine to occasionally tap into. The volatility of the electricity market provides intermittent spikes in oxygen value. Should the price of oxygen also spike, partial oxidation can temporarily cease—but this is not a large cost due to the low cost of reformers—$200/kW.

Therefore, a supply of pure oxygen is available for the turbine. The goal of dispatchable heat engine, which provides electricity on demand, but a minority of the time, can be accomplished without any idling Carbon Capture equipment (FIG. 3) or any idling capital intensive heat sources (FIG. 2).

It should be mentioned that partial oxidation does result in the production of CO₂ (23) However, this CO₂ does not require gas separation, or “Carbon Capture” in the traditional sense. CO₂ in this case is separated from hydrogen, need to be separated anyway. This can be done through a membrane or pressure swing absorption and is viewed as a minor inconvenience as hydrogen is so small that is it relatively easy to separate.

FIG. 4 illustrates the Thermal Hydrogen storage system. The system consists of the energy components shown and labeled. This is an energy system intended to reform chemical energy carriers and hydrocarbons to pumpable liquid fuels with the minimum capital intensity and the minimum energy lost.

This is accomplished by allowing most of the chemical energy carrier produced in the system to come from auto-thermal reforming, a process which is neither exothermic or endothermic. The waste heat of all exothermic processes, as labeled in the FIG. 24), are intended to augment partial oxidation of hydrocarbons.

Methanol is produced and stored in liquid form. Methanol acts as the ultimate source of storage in the economy. Methanol is produced from syngas and requires half the amount of oxygen as hydrogen production. It can be stored for an infinitely long period, and then used in a fuel cell which can be can provide power to the grid. The liquid nature of refueling provides distributed capacity with unmatchable reliability—in an emergency, cars can simply refuel.

For the system as a whole, methanol can be reformed easily back into syngas, and it can then be converted to hydrogen using the water gas shift reaction (25). Because the other fuels require cold storage, and because oxygen supply is intermittent, this methanol provides the function of minimizing the need for cold storage.

Cold storage is provided by utilizing the wasted cooling of the air separation unit. This can be provided by either cold oxygen or cold nitrogen, but the embodiment shown uses the nitrogen. The cooling from the ASU minimizes the amount of compressive work required to store ammonia (26), oxygen (27), and to sequester CO₂ (28).

The cooling provided to these chemicals is not wasted as it can be recollected after these chemicals are pumped to the pressure required for distribution at atmospheric temperature. After the cold liquids are pumped to pressure, their cooling is transferred once again to the incoming air to the ASU.

FIG. 5 illustrate the Thermal Hydrogen distribution system. Methanol is distributed to the gas tank of the vehicle (29). The waste heat from the SOFC is utilized to reform methanol back into syngas (30), to preheat incoming air (31), and then to heat the vehicle cabin (32).

The syngas is then utilized in a solid oxide fuel cell producing only carbonated water (33) which is not diluted with nitrogen (34). Solid oxide fuel cells can perform this function because the oxygen crosses the electrolyte rather than hydrogen. Because only carbonated water is produced, the products are five to ten time smaller than the exhaust from an internal combustion vehicle.

The CO₂ (and possibly also the water) is stored onboard the vehicle (35), recollected by the gas station, returned to the CO₂ sequestration network either through piping or by utilizing the empty methanol truck to move the CO₂.

The following numbered clauses set out specific embodiments that may be useful in understanding the present invention:

1. A method of operating a system comprising an electrical power plant, an electrolyser connected to a regional electrical power grid, and a hydrocarbon oxidation device, comprising:

providing water and/or carbon dioxide to the electrolyser;

providing electricity from the regional electrical power grid to the electrolyser for electrolysis of the water and/or carbon dioxide to produce oxygen; and

providing the oxygen from the electrolyser to the hydrocarbon oxidation device for the oxidation of a hydrocarbon.

2. The method of clause 1 wherein the electrical power plant has a utilization rate of less than 50% of its availability when the marginal price of electricity on the regional electrical power grid is less than two times the regional wholesale cost of natural gas.
3. The method of clause 1 or 2 wherein the electrical power plant has a utilization rate of less than 50% of its availability when the marginal price of electricity on the regional electrical power grid is less than three times the regional wholesale cost of natural gas.
4. The method of any one of clauses 1-3 wherein the electrolyser has a utilization rate of less than 50% of its availability when the marginal price of electricity on the regional electrical power grid is more than one and a half times the regional wholesale cost of natural gas.
5. The method of any one of clauses 1-4 wherein the electrolyser has a utilization rate of less than 50% of its availability when the marginal price of electricity on the regional electrical power grid is more than two times the regional wholesale cost of natural gas.
6. The method of any one of clauses 1-5, wherein heat from the electrical power plant is provided to the electrolyser for heat-assisted electrolysis.
7. The method of any one of clauses 1-6, wherein electricity from the electrical power plant is provided to the electrolyser when supply of electricity from the electrical power plant exceeds other electricity demand.
8. The method of any one of clauses 1-7, wherein the hydrocarbon oxidation device at least partially oxidizes the hydrocarbon to produce hydrogen or syngas.
9. The method of any one of clauses 1-7, comprising providing the hydrogen or syngas to a solid oxide fuel cell.
10. The method of clause 8, wherein the hydrocarbon oxidation device is an auto-thermal reformer or hydrocarbon gasifier.
11. The method of clause 10, wherein the hydrocarbon is methane.
12. The method of clause 10, wherein the hydrocarbon is coal or biomass.
13. The method of any one of clauses 1-12, comprising providing the oxygen to an oxy-fueled power plant.
14. The method of clause 13, wherein the oxy-fueled power plant is an Allam cycle power plant.
15. The method of any one of clauses 1-14, wherein the electrical power plant is a nuclear power plant, a solar thermal or concentrated photovoltaic power plant, or geothermal power plant.
16. The method of any one of clauses 1-15, wherein the electrical power plant has an electricity generating capacity of at least 50 megawatts.
17. The method of any one of clauses 1-16, wherein the electrical power plant has an electricity generating capacity of at least 100 megawatts.
18. A system comprising:

an air separation unit, a hydrocarbon reformer, and a Haber-Bosch process unit;

wherein the air separation unit provides nitrogen to the Haber-Bosch process unit;

wherein the hydrocarbon reformer unit provides hydrogen to the Haber-Bosch process unit.

19. The system of clause 18 comprising a methanol reformer;

wherein the hydrocarbon reformer provides hydrogen and/or carbon monoxide to the methanol reformer.

20. The system of clause 19 comprising a water gas shift reaction providing hydrogen and/or carbon monoxide to the methanol reformer.
21. The system of clause 18 comprising a water gas shift reaction providing hydrogen to the Haber-Bosch process.
22. The system of clause 20 or 21 comprising a heat exchanger to transfer heat from carbon dioxide from the hydrocarbon reformer to nitrogen from the air separation unit.
23. The system of any one of clauses 18-22 comprising a heat exchanger to transfer heat from the ammonia from the Haber-Bosch process unit into nitrogen from the air separation unit.
24. The system of any one of clauses 18-23 comprising a heat exchanger to transfer heat from air entering the air separation unit to ammonia from the Haber-Bosch process unit, carbon dioxide from the hydrocarbon reformer and/or oxygen from the air separation unit.
25. A vehicle comprising:

a fuel tank containing methanol;

a heat exchanger arranged to convert the methanol into syngas; and

a solid oxide fuel cell arranged to receive the syngas and generate electricity;

wherein heat from the solid oxide fuel cell is transferred into the methanol through said heat exchanger.

26. The vehicle of clause 25 comprising an exhaust tank for receiving carbon dioxide, and/or water, from the solid oxide fuel cell.
27. The vehicle of clause 26 wherein the fuel tank and the exhaust tank are separated by a movable membrane that moves in response to a pressure differential between the fuel tank and the exhaust tank.
28. The vehicle of clause 26 wherein the exhaust tank is insulated with an insulation having an R-Value of at least 10.
29. The vehicle of clause 28 wherein the exhaust tank is insulated with an insulation having an R-Value of at least 20.
30. The vehicle of clause 28 or 29, wherein the exhaust tank stores the heat from exhaust from the solid oxide fuel cell for later release to the vehicle cabin or connecting member to outside heat demand.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method of operating a system comprising an electrical power plant, an electrolyser connected to a regional electrical power grid, and a hydrocarbon oxidation device, comprising:
providing water and/or carbon dioxide to the electrolyser;
providing electricity from the regional electrical power grid to the electrolyser for electrolysis of the water and/or carbon dioxide to produce oxygen; and
providing the oxygen from the electrolyser to the hydrocarbon oxidation device for the oxidation of a hydrocarbon.

2. The method of claim 1 wherein the electrical power plant has a utilization rate of less than 50% of its availability when the marginal price of electricity on the regional electrical power grid is less than two times the regional wholesale cost of natural gas.

3. The method of claim 2 wherein the electrical power plant has a utilization rate of less than 50% of its availability when the marginal price of electricity on the regional electrical power grid is less than three times the regional wholesale cost of natural gas.

4. The method of claim 1 wherein the electrolyser has a utilization rate of less than 50% of its availability when the marginal price of electricity on the regional electrical power grid is more than one and a half times the regional wholesale cost of natural gas.

5. The method of claim 4 wherein the electrolyser has a utilization rate of less than 50% of its availability when the marginal price of electricity on the regional electrical power grid is more than two times the regional wholesale cost of natural gas.

6. The method of claim 1, wherein heat from the electrical power plant is provided to the electrolyser for heat-assisted electrolysis.

7. The method of claim 1, wherein electricity from the electrical power plant is provided to the electrolyser when supply of electricity from the electrical power plant exceeds other electricity demand.

8. The method of claim 1, wherein the hydrocarbon oxidation device at least partially oxidizes the hydrocarbon to produce hydrogen or syngas.

9. The method of claim 8, comprising providing the hydrogen or syngas to a solid oxide fuel cell.

10. The method of claim 8, wherein the hydrocarbon oxidation device is an auto-thermal reformer or hydrocarbon gasifier.

11. The method of claim 10, wherein the hydrocarbon is methane.

12. The method of claim 10, wherein the hydrocarbon is coal or biomass.

13. The method of claim 1, comprising providing the oxygen to an oxy-fueled power plant.

14. The method of claim 13, wherein the oxy-fueled power plant is an Allam cycle power plant.

15. The method of claim 1, wherein the electrical power plant is a nuclear power plant, a solar thermal or CPV power plant, or geothermal power plant.

16. The method of claim 1, wherein the electrical power plant has an electricity generating capacity of at least 50 megawatts.

17. The method of claim 1, wherein the electrical power plant has an electricity generating capacity of at least 100 megawatts.

18. A system comprising:
an air separation unit, a hydrocarbon reformer, and a Haber-Bosch process unit;
wherein the air separation unit provides nitrogen to the Haber-Bosch process unit;
wherein the hydrocarbon reformer unit provides hydrogen to the Haber-Bosch process unit.

19. The system of claim 18 comprising a methanol reformer;
wherein the hydrocarbon reformer provides hydrogen and/or carbon monoxide to the methanol reformer.

20. The system of claim 19 comprising a water gas shift reaction providing hydrogen and/or carbon monoxide to the methanol reformer.
